(19) United States
(12) Patent Application Publication
(10) Pub. No.: US 2023/0365048 A1
(43) Pub. Date: Nov. 16, 2023

(54) Truck Trailer Door Closure and Detection System

(71) Applicants: Garrett Schneider, Clinton, WI (US); Kelby Schneider, Clinton, WI (US); Anna Turner, Beloit, WI (US); Evan Schneider, Clinton, WI (US)

(72) Inventors: Garrett Schneider, Clinton, WI (US); Kelby Schneider, Clinton, WI (US); Anna Turner, Beloit, WI (US); Evan Schneider, Clinton, WI (US)

(21) Appl. No.: 18/196,685

(22) Filed: May 12, 2023

Related U.S. Application Data
(60) Provisional application No. 63/341,263, filed on May 12, 2022.

(51) Int. Cl. B60P 3/04; B60Q 5/00; B60Q 9/00

(52) U.S. Cl. CPC B60P 3/04; B60Q 5/005; B60Q 9/00

(57) ABSTRACT

A truck trailer door closure and detection system comprises a gravity-assisted latch for holding a livestock door closed on a truck trailer. In addition, the system comprises a detector for detecting when a livestock door on a truck trailer opens and for alerting a truck driver in the event a livestock door opens during travel.

### CROSS-REFERENCE TO RELATED APPLICATIONS

The present invention claims priority to U.S. Prov. Pat. App. No. 63/341,263, titled “Truck Trailer Door Closure and Detection System,” filed May 12, 2022, which is incorporated herein by reference in its entirety.

### TECHNICAL FIELD

The present invention relates to a truck trailer door closure and detection system. Specifically, the system comprises a gravity-assisted latch for holding a livestock door closed on a truck trailer. In addition, the system comprises a detector for detecting when a livestock door on a truck trailer opens and for alerting a truck driver in the event a livestock door opens during travel.

### BACKGROUND

According to the National Cattle and Beef Association, between about 500,000 and 600,000 cattle are hauled on American roads each day. In addition, the American Association of Veterinarians estimates that over 1 million hogs are transported each day in America. The transportation of livestock across the United States contributes to a meat packing and processing industry that is worth an estimated 152.5 billion dollars. Most animals arrive at processing plants without issue, but some are lost and/or damaged during transport.

One problematic issue concerning the transport of livestock on truck trailers involves the accidental release of livestock from truck trailers during the transport. Specifically, cattle can cause damage to livestock doors on truck trailers and hogs have been known to use their snouts to open the doors. Typically, livestock doors are held with a simple rope system that can be easy for livestock to damage or manipulate. On average, truck trailer doors must be replaced every 4 years due to damage. And once the truck trailer livestock doors open during transport, livestock can fall out of the trailers onto roads, where they can be seriously injured, killed, and/or lost. In most cases, truck drivers have no idea they have lost livestock until they arrive at their destination or otherwise stop for another reason.

A need, therefore, exists for an improved truck trailer livestock door closure and detection system. Specifically, a need exists for an improved truck trailer livestock door system that more securely holds a truck trailer livestock door closed during transport. More specifically, a need exists for an improved truck trailer livestock door system that is easy to manipulate by a user thereof and is difficult for livestock to damage or open, especially during transport.

Moreover, a need exists for an improved truck trailer livestock door system that alerts a driver if a truck trailer livestock door opens during transport. Specifically, a need exists for a sensor that is positioned on a door that effectively and accurately detects when a trailer livestock door opens. More specifically, a need exists for a sensor that is robust and can be used in all kinds of weather without being damaged.

### SUMMARY OF THE INVENTION

The present invention relates to a truck trailer door closure and detection system. Specifically, the system comprises a gravity-assisted latch for holding a livestock door closed on a truck trailer. In addition, the system comprises a detector for detecting when a livestock door on a truck trailer opens and for alerting a truck driver in the event a livestock door opens during travel.

To this end, in an embodiment of the present invention for moving livestock is provided. The truck trailer comprises: a cab; a trailer attached to the cab for hauling livestock in an internal space, the trailer comprising a door having a closure for ingress in to and egress out of the trailer; and a livestock door closure and detection system comprising a latch configured to maintain the door in a closed configuration, and a sensor adjacent the door that is configured to trigger an indicator to a truck driver within the cab when the door is open.

In an embodiment, the latch is a gravity assisted latch.

In an embodiment, the latch is disposed on a bottom of the door.

In an embodiment, the latch is disposed outside the internal space of the trailer.

In an embodiment, the sensor is a proximity sensor.

In an embodiment, the sensor detects a detectable metal adjacent the proximity sensor when the door is in the closed position but fails to detect the detectable metal when the door is in the open position.

In an embodiment, the indicator is selected from the group of a visible indicator, an audible indicator, and a combination of a visible indicator and an audible indicator.

In an embodiment, the indicator is a light.

In an embodiment, the indicator is disposed within the cab.

In an embodiment, the indicator is disposed on a front surface of the trailer and is configured to be detectable by the driver in the cab.

In an alternate embodiment of the present invention, a livestock trailer door closure and detection system is provided. The system comprises: a sensor configured to be placed adjacent a door on a livestock trailer; and an indicator configured to be triggered when the door is in an open configuration and visible to a driver of the truck when the driver is in a cab pulling the livestock trailer.

In an embodiment, the sensor is a proximity sensor.

In an embodiment, the sensor is configured to detect a metal material disposed adjacent to the proximity sensor when the door is in an open configuration and fails to detect the metal material when the door is in a closed configuration.

In an embodiment, the indicator is selected from the group of a visible indicator, an audible indicator, and a combination of a visible indicator and an audible indicator.

In an embodiment, the indicator is a light.

In an embodiment, the livestock trailer door closure and detection system further comprises: a latch configured to maintain the door in a closed configuration.

In an embodiment, the closure is gravity assisted to maintain the door in the closed configuration.

In an embodiment, the closure is disposed on a bottom of the door.

In an embodiment, the indicator is disposed within the cab.

In an embodiment, the indicator is disposed on the trailer.

It is, therefore, an advantage and objective of the present invention to provide an improved truck trailer livestock door system.

Specifically, it is an advantage and objective of the present invention to provide an improved truck trailer livestock door system that more securely holds a truck trailer livestock door closed during transport.

More specifically, it is an advantage and objective of the present invention to provide an improved truck trailer livestock door system that is easy to manipulate by a user thereof and is difficult for livestock to damage or open, especially during transport.

Moreover, it is an advantage and objective of the present invention to provide an improved truck trailer livestock door system that alerts a driver if a truck trailer livestock door opens during transport.

Specifically, it is an advantage and objective of the present invention to provide a sensor that is positioned on a door that effectively and accurately detects when a trailer livestock door opens.

More specifically, it is an advantage and objective of the present invention to provide a sensor that is robust and can be used in all kinds of weather without being damaged.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a truck trailer livestock door closure system in an embodiment of the present invention.

FIG. 2 illustrates a perspective view of a truck trailer livestock door gravity-assisted latch in an embodiment of the present invention.

FIG. 3 illustrates an electrical schematic diagram of a truck trailer livestock door proximity sensor in an embodiment of the present invention.

### DETAILED DESCRIPTION OF THE PRESENTLY PREFERRED EMBODIMENTS

The present invention relates to a truck trailer door closure and detection system. Specifically, the system comprises a gravity-assisted latch for holding a livestock door closed on a truck trailer. In addition, the system comprises a detector for detecting when a livestock door on a truck trailer opens and for alerting a truck driver in the event a livestock door opens during travel.

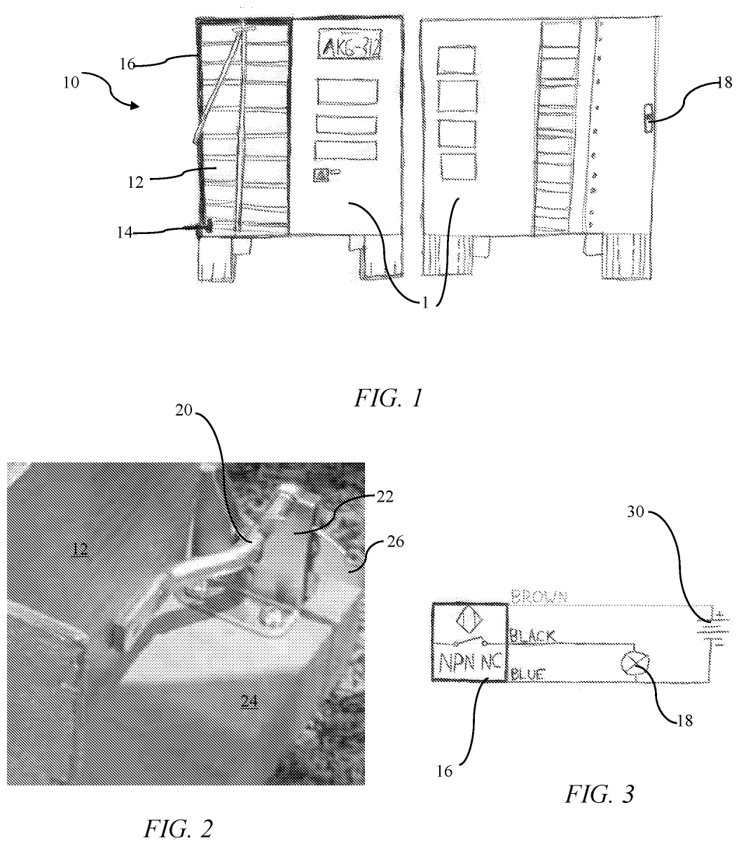

In an embodiment of the present invention, illustrated in FIG. 1, an improved truck trailer livestock door system 10 for a truck trailer livestock door 12 disposed on a truck trailer 1 is provided. The system 10 comprises a gravity assisted latch 14 disposed on a bottom of the livestock door 12 that is shown in more detail in FIG. 2. In addition, the system 10 comprises a sensor or switch 16 associated with the door 12 to visually indicate to a driver via a light 18 that the livestock door 12 is open.

Referring to FIG. 2, the gravity-assisted latch 14 is illustrated in more detail. Specifically, the gravity-assisted latch 14 comprises a peg 20 extending from a bottom of the trailer livestock door 12 that may extend out and away from the trailer livestock door 12 and outside the internal space of the truck trailer so that the same is inaccessible to livestock that may be contained therein. A latch catch plate 22 may be disposed on a floor 24 of the truck trailer 1 having a release 26 therein. In use, the peg 20 may be lifted by lifting the door 12. As the door 12 is closed, the peg may be placed or disposed within the latch catch plate 22, thereby closing the release 26 therearound. Thus, simply allowing the peg 20 to fall into the catch plate 22 by gravity may close and secure the peg 20 and, thus, the trailer livestock door 12. The release 26 is positioned outside and away from the internal space of the truck trailer so that it is inaccessible to livestock contained therein. Gravity aids in maintaining the peg 20 within the catch plate 22, thereby making it more difficult for the truck trail livestock door 12 to be accidentally opened.

FIG. 3 illustrates a simple circuit diagram of the sensor or switch 16 that may detect when the truck trailer livestock door is opened and further alert a driver that the door is opened during transport via the light 18. Specifically, the sensor or switch 16 may be a proximity sensor that may detect when the door is not in the closed position. More specifically, the proximity sensor may preferably be an inductive switch that senses the closure of the truck trailer livestock door 12 via detection of surrounding metal by detecting magnetic fields without requiring contact to do so. As illustrated in FIG. 3, the proximity switch 16 may be powered by a standard vehicle battery 30, which may preferably be the truck battery. In the event that the door or surrounding material is not made of a detectable metal, a detectable metal may be added to the door, the frame, or in any other location adjacent the sensor or switch 16 (when the door is in the closed position) such that when the door is closed, the sensor or switch 16 is assured of detecting the detectable metal and when the door is opened, the sensor or switch 16 fails to detect the detectable metal.

Likewise, the light 18, also wired to the vehicle battery 30, may be activated when the proximity switch 16 fails to detect the requisite magnetic field of the metal trailer door 12 or other metal object or material on the truck trailer door 12. Thus, when the door 12 is closed, the proximity switch 16 is off and the light 32 remains off. However, when the door is open, the proximity switch 16 activates, thereby completing the circuit to the light 18. The sensor or switch 16 may preferably be positioned near the top of the door, placed relatively high on the trailer 1 so that the same may also be inaccessible thereby preventing damage thereto or false detection of other metal objects.

The light 18 may preferably be positioned on a front 2 of the trailer 1 (as illustrated in FIG. 1), preferably in a top corner thereof. Thus, the light 18 may be in a position that may be easily seen by the truck driver during transport. Alternatively, the light 18 may be positioned in other locations that are also easily seen by the driver, such as in the cab itself.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A truck trailer for moving livestock comprising:
a cab;
a trailer attached to the cab for hauling livestock in an internal space, the trailer comprising a door having a closure for ingress in to and egress out of the trailer; and
a livestock door closure and detection system comprising a latch configured to maintain the door in a closed configuration, and a sensor adjacent the door that is configured to trigger an indicator to a truck driver within the cab when the door is open.

2. The truck trailer of claim 1 wherein the latch is a gravity assisted latch.

3. The truck trailer of claim 1 wherein the latch is disposed on a bottom of the door.

4. The truck trailer of claim 1 wherein the latch is disposed outside the internal space of the trailer.

5. The truck trailer of claim 1 wherein the sensor is a proximity sensor.

6. The truck trailer of claim 1 wherein the sensor detects a detectable metal adjacent the proximity sensor when the door is in the closed position but fails to detect the detectable metal when the door is in the open position.

7. The truck trailer of claim 1 wherein the indicator is selected from the group of a visible indicator, an audible indicator, and a combination of a visible indicator and an audible indicator.

8. The truck trailer of claim 1 wherein the indicator is a light.

9. The truck trailer of claim 1 wherein the indicator is disposed within the cab.

10. The truck trailer of claim 1 wherein the indicator is disposed on a front surface of the trailer and is configured to be detectable by the driver in the cab.

11. A livestock trailer door closure and detection system comprising:
a sensor configured to be placed adjacent a door on a livestock trailer; and
an indicator configured to be triggered when the door is in an open configuration and visible to a driver of the truck when the driver is in a cab pulling the livestock trailer.

12. The livestock trailer door closure and detection system of claim 11 wherein the sensor is a proximity sensor.

13. The livestock trailer door closure and detection system of claim 11 wherein the sensor is configured to detect a metal material disposed adjacent to the proximity sensor when the door is in an open configuration and fails to detect the metal material when the door is in a closed configuration.

14. The livestock trailer door closure and detection system of claim 11 wherein the indicator is selected from the group of a visible indicator, an audible indicator, and a combination of a visible indicator and an audible indicator.

15. The livestock trailer door closure and detection system of claim 11 wherein the indicator is a light.

16. The livestock trailer door closure and detection system of claim 11 further comprising:
a latch configured to maintain the door in a closed configuration.

17. The livestock trailer door closure and detection system of claim 11 wherein the closure is gravity assisted to maintain the door in the closed configuration.

18. The livestock trailer door closure and detection system of claim 11 wherein the closure is disposed on a bottom of the door.

19. The livestock trailer door closure and detection system of claim 11 wherein the indicator is disposed within the cab.

20. The livestock trailer door closure and detection system of claim 11 wherein the indicator is disposed on the trailer.
